(19) United States
(12) Patent Application Publication
(10) Pub. No.: US 2012/0020568 A1
(43) Pub. Date: Jan. 26, 2012

(54) IMAGE PROCESSOR AND IMAGE PROCESSING METHOD

(75) Inventor: Takayuki KOGANE, Tokyo (JP)

(73) Assignee: CASIO COMPUTER CO., LTD., Tokyo (JP)

(21) Appl. No.: 13/188,064

(22) Filed: Jul. 21, 2011

(30) Foreign Application Priority Data
Jul. 23, 2010 (JP) 2010-165642

(51) Int. Cl. G06K 9/46

(52) U.S. Cl. 382/195

(57) ABSTRACT

An image processor for implementing an image turning operation of turning a photographic image showing a person into an image having a painting effect comprises a face detection part for capturing an image and detecting an image of the face of a person shown in the image so captured, a determination part for determining whether or not the mage of the face of the person detected meets a predetermined criterion, and an image turning operation implementing part for implementing an image turning operation of turning the image into an image having a painting effect based on the result of the determination. When the photographic image showing the person is turned into an image having a painting effect, whether or not the photographic image is turned into an image having a painting effect is determined in consideration of the position and size of the person in the photographic image, as well as orientations of the face and a line of sight of the person.

### CROSS-REFERENCE TO RELATED APPLICATION

This application is based upon and claims under 35, USC 119 the benefit of priority from the prior Japanese Patent Application No. 2010-165642 filed on Jul. 23, 2010, the entire contents of which are incorporated herein by reference.

### BACKGROUND OF THE INVENTION

1. Field of the Invention

The present invention relates to an image processor and an image processing method for turning a digital photographic image into a “painting” or an image having a painting effect.

2. Description of the Related Art

In recent years, as digital cameras are widely used, it is getting general practice to store photographs in the form of digital image data. This changes the way in which users enjoy photographing by looking at photographs taken or captured images on their digital cameras used to capture those digital images or on personal computers into which image data of the captured images are transferred for storage therein. For example, a technique (an image turning or more particularly painting effect application technique) has been proposed in which image data is subjected to image processing to turn an original digital image into an image having a painting effect (such as of oil painting) which gives it a unique touch based on the original for display (refer to JP-A-8-44867, for example).

In addition, JP-A-2002-298136 describes a technique in which an original image produced by a digital camera or through CG (Computer Graphics) which creates a “mechanical touch” is turned into an image having a painting effect using a computer.

However, the image having the painting effect that is obtained by the image processing described above is represented as being blurred (less sharp) when compared with the original image by making the image look like a painting painted. Because of this, for example, with a photographic image (for example, a group photo) captured by the user of a digital camera which shows the face of a person as a subject looking small, when an image processing like the one described above is implemented on the photographic image, there may be a situation in which the face of the subject person, which is represented sharp in the photographic image, is represented as being painted out in a painting-style image resulting from the image processing. As this occurs, the face of the person cannot be recognized. However, this will be no problem in case that person is a person (a pedestrian, for example) whose image was captured irrespective of the intention of the camera user. However, there will be caused a problem when the person is a person (a main subject) whose image was captured positively by the camera user, and it is said that the above image processing is not suitable.

### BRIEF SUMMARY OF THE INVENTION

The invention has been made in view of these situations, and an object thereof is to provide an image processor and an image processing method which can implement preferably an image turning operation of turning a photographic image showing a person as a subject into an image having a painting effect or a painting-style image.

An image processor of the invention comprises a face detection part for capturing an image and detecting an image of a face shown in the image so captured, a determination part for determining whether or not the image of the face detected by the face detection part meets a predetermined criterion, and an image turning operation implementing part for determining on execution or non-execution of an image turning operation of turning the image into a painting-style image based on the result of the determination made by the determination part and executing the image turning operation when it is determined that the image turning operation be executed.

According to the invention, the image turning operation can preferably be implemented in which a photographic image showing the face of a person or the like is turned into an image having a painting effect or a painting-style image.

### BRIEF DESCRIPTION OF THE DRAWINGS

FIG. 1 is a block diagram of an image processor according to an embodiment of the invention.

FIG. 2 is a block diagram showing a hardware configuration of the image processor according to the embodiment of the invention.

FIG. 3 is a flowchart showing an image processing which is implemented by the image processor according to the embodiment of the invention.

FIG. 4 is a diagram showing dividing lines shown on a display screen of a display unit shown in FIG. 1.

FIG. 5 is a diagram showing a region in relation to a first criterion used by the image processor according to the embodiment of the invention.

FIG. 6 is a diagram showing the face of a person shown in a photographic image when the first criterion used by the image processor according to the embodiment of the invention is met.

FIG. 7 is a diagram showing the faces of a person shown in a photographic image when the first criterion used by the image processor according to the embodiment of the invention is not met.

FIG. 8 is a diagram showing a region in relation to a second criterion used by the image processor according to the embodiment of the invention.

FIG. 9 is a diagram showing the face of a person shown in a photographic image when the second criterion used by the image processor according to the embodiment of the invention is met.

FIG. 10 is a diagram showing the face of a person shown in a photographic image when the second criterion used by the image processor according to the embodiment of the invention is not met.

FIG. 11 is a diagram showing the face of a person shown in a photographic image when a third criterion used by the image processor according to the embodiment of the invention is not met (when the face is not directed to the front).

FIG. 12 is a diagram showing the face of a person shown in a photographic image when the third criterion used by the image processor according to the embodiment of the invention is not met (the line of sight is not directed to the front).

### DETAILED DESCRIPTION OF THE PREFERRED EMBODIMENT

An embodiment according to the invention will be described below by reference to the drawings.

Although the invention will be understood sufficiently from the following detailed description and the accompanying drawings, the detailed description and accompanying drawings are mainly intended for description, and the scope of the invention is not limited thereby in any way.

At first, an image processor according to the invention will be described briefly. In this embodiment, an image processor will be described as being a digital camera. The image processor has an image turning or more particularly painting effect application mode as an image capture mode. The painting effect application mode is the image capture mode in which automatically implemented is an image turning operation of turning a photographic image captured by the image processor in accordance with an image capturing operation by the user of the image processor into an image having a painting effect (hereinafter, referred to as a painting-style image). The painting-style image obtained by this image processor is such as to be represented as if it were painted based on the original photographic image, and those who look at the painting-style image can feel an impression which differs from the effect (the painting style) given by the original photographic image. Note that painting styles include an oil painting touch, a watercolor painting touch, a pastel painting touch and the like. The image turning operation of turning the photographic image into the painting-style image can make use of the processing implemented in Photoshop (the registered trademark),

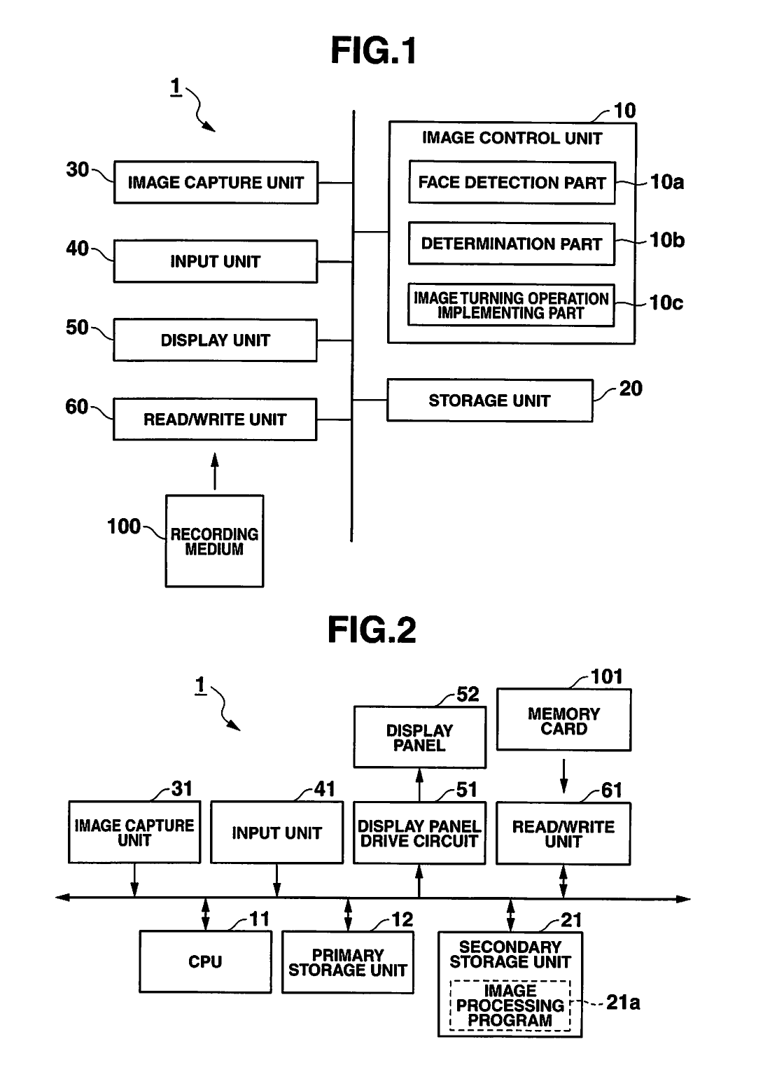

Following this, the configuration of an image processor 1 will be described by reference to FIG. 1. The image processor 1 includes a control unit 10, a storage unit 20, an image capture unit 30, an input unit 40, a display unit 50, and a read/write unit 60.

The control unit 10 controls the individual constituent units of the image processor 1, as well as the image processor in whole. In addition, the image control unit 10 includes a face detection part 10a, a determination part 10b and an image turning operation implementing part 10c and implements an image processing, which will be described later.

The storage unit 20 stores, under the control of the control unit 10, various data for use in implementing an image processing, which will be described later. In addition, the storage unit 20 stores various image data generated by the control unit 10 during processing and recorded image data read out from a recording medium 100 by the read/write unit 60 as required.

The image capture unit 30 captures a photographic image under the control of the control unit 10. The image capture unit 30 generates a captured image signal representing the photographic image so captured and generates photographic image data representing a photographic image of one frame (one photograph) based on the captured image signal generated. The image capture unit 30 supplies the control unit 10 with the photographic image data so generated. The control unit 10 receives the photographic image data so supplied. The control unit 10 may obtain the photographic image data through a configuration in which the image capture unit 30 supplies the control unit 10 with predetermined data which represents the photographic image and the control unit 10 implements a predetermined operation on the predetermined data supplied to generate photographic image data. The photographic image is a still image, and the photographic image data is still image data which represents the still image.

The input unit 40 is an operation unit which is operated by the user and supplies the control unit 10 with operation signals corresponding to the contents of the operations implemented thereon by the user.

The display unit 50 displays a menu screen, a live view display screen and painting-style images (images of an oil painting touch, a patched paper work touch, a black-and-white drawing touch and the like) under the control of the control unit 10 (the image turning operation implementing part 10c).

The read/write unit 60 reads out recorded image data from the recording medium 100 and writes image data on the recording medium 100 for recording under the control of the control unit 10.

Next, a hardware configuration of the image processor 1 will be described by reference to FIG. 2. The image processor 1 includes a CPU (Central Processing Unit) 11, a primary storage unit 12, a secondary storage unit 21, an image capture unit 31, an input unit 41, a display panel drive circuit 51, a display panel 52 and a read/write unit 61.

The control unit 10 shown in FIG. 1 is realized by the CPU 11 and the primary storage unit 21. The CPU 11 controls the image processor 1 in whole in accordance with an image processing program 21a which is loaded in the primary storage unit 12 from the secondary storage unit 21. In particular, the CPU 11 actually implements in accordance with the image processing program 21a the image processing that is implemented by the control unit 10 (the face detection part 10a, the determination part 10b and the image processing operation implementing part 10c) shown in FIG. 1, and this image processing will be described later. The control unit 10 may further include an ASIC (Application Specific Integrated Circuit), a DSP (Digital Signal Processor) and the like. As this occurs, the ASIC and the DSP implement at least part of the processing implemented by the CPU 11.

The primary storage unit 12 is realized by a RAM (Random Access Memory). The primary storage unit 12 stores temporarily data used and data generated by the CPU 11 as required.

The storage unit shown in FIG. 1 is realized by the secondary storage unit 21. The secondary storage unit 21 is made up of flash memory or a hard disk. In addition, the secondary storage unit 21 stores the image processing program 21a. The CPU 11 loads the image processing program 21a stored in the secondary storage unit 21 on the primary storage unit 12 and implements the image processing, which will be described later, based on a command given by the image processing program 21a stored in the primary storage unit 21.

The image capture unit 30 shown in FIG. 1 is realized by the image capture unit 31. The image capture unit 31 includes an image capture device such as a CCD (Charge Coupled Device) image sensor or a CMOS (Complementary Metal Oxide Semiconductor) image sensor, an AFE (Analog Front End), and a DSP (Digital Signal Processor).

The image capture unit 31 captures a photographic image in accordance with an image capturing operation performed by the user of the image processor 1, generates a captured image signal which represents the photographic image captured, implements various types of processing (processing carried out in the AFE, DPS and the like) on the captured image signal so generated and generates digital photographic image data. The various types of processing include, for example, a correlated double sampling operation, an automatic gain control operation which his implemented on a captured image signal after the correlated double sample operation, an analog/digital conversion operation of converting an analog captured image signal after the automatic gain control operation into a digital signal, and operations to be implemented so as to increase the image quality such as edge enhancement, auto white balance, auto-iris and the like.

The image capture unit 31 supplies the primary storage unit 12 with the photographic image data generated. The primary storage unit 12 stores the photographic image data received from the image capture unit 31 as still image data. The CPU 11 uses the still image data stored in the primary storage unit 12 to implement the image processing, which will be described later. Operations which are implemented by the DSP (Digital Signal Processor) of the image capture unit 31 may be implemented by the CPU 11.

The input unit 40 shown in FIG. 1 is realized by the input unit 41. The input unit 41 is an interface unit which is operated by the user. The input unit 41 includes various types of operation keys such as an image capture key, a menu key, an image capturing mode (including an image turning or more particularly painting effect application mode) selection key, and a power on/off key. When the user operates these keys, the input unit 41 generates operation signals corresponding to the keys operated and supplies the CPU 11 with the operation signals so generated. When receiving the operation signals, the CPU 11 implements operations corresponding to the operation signals received.

The display unit 50 shown in FIG. 1 is realized by the display panel drive circuit 51 and the display panel 52. The CPU 11 uses the various types of image data so as to generate display image data (for example, RGB (Red-Green-Blue) data) and supplies the display panel drive circuit 51 with the display image data generated. The display panel drive circuit 51 receives the display image data from the CPU 11 so as to drive the display panel 52 and displays an image represented by the display image data on the display panel 52. In this way, the CPU 11 uses the predetermined image data so as to display the image represented by this mage data on the display panel 52 of the display unit 50. The display panel 52 is made up of, for example, a liquid crystal display panel or an OEL (Organic Electro-Luminescence) display panel. An image is displayed on the display panel 52 by the display panel drive circuit 51.

Note that the input unit 40 and the display unit 50 which are shown in FIG. 1 may be realized by a touch panel. As this occurs, the input unit 41 and the display panel 52 are realized by a touch panel. The touch panel displays an input screen which receives predetermined operations performed by the user and supplies the CPU 11 with operation signals which correspond to positions on the input screen where the user touches.

The read/write unit 60 shown in FIG. 1 is realized by the read/write unit 61. The read/write unit 61 is an interface unit which reads and writes data from and on to a memory card 101.

The recording medium 100 is realized by the memory card 101 which is of a flash memory type. An SD memory card is used as the memory card 101.

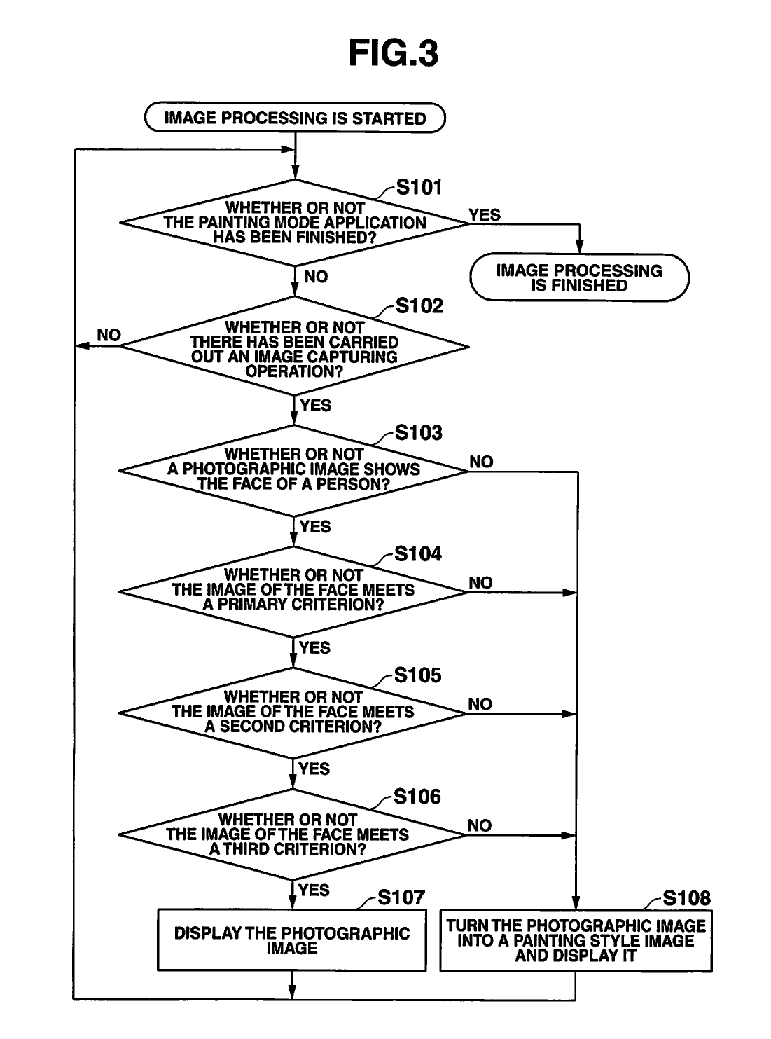

Next, referring to FIG. 3, an operation of the image processor 1 when the user selects the painting effect application mode will be described.

After electric power is introduced into the image processor 1, the user selects the painting effect application mode from the menu screen displayed on the display unit 50 by using the input unit 40. In addition, the user selects one of painting effects or styles including watercolor painting, color pencil sketch, pastel painting, pointillism, air brush painting, oil painting, and Gothic oil painting by using the input unit 40. The input unit 40 supplies an operation signal corresponding to the operation implemented by the user with the face detection part 10a.

The face detection part 10a makes the image capture unit 30 capture present images at a predetermine frame rate and obtains sequentially photographic image data (live view image data) which represent the present images from the image capture unit 30. The live view image data is image data of a low resolution for live view. The face detection part 10a displays live view images represented by the live view image data sequentially obtained from the image capture unit 30 on the display screen of the display unit 50, whereby the user can acquire images while verifying live view images.

Next, the face detection part 10a determines whether or not the painting effect application mode is finished (step S101). When the user finishes the painting effect application mode by operating the input unit 40, the face detection unit 10a receives an operation signal corresponding to the operation implemented by the user from the input unit 40. When receiving this operation signal, the face detection unit 10a determines that the painting effect application mode has been finished (step S101: YES) and ends the image processing. On the other hand, the face detection unit 10a determines that the painting mode application mode has not yet been finished in any other cases (step S101: NO).

If the face detection part 10a determines that the painting effect application mode has not yet been finished (step S101: NO), the face detection part 10 determines whether or not there has been carried out an image capturing operation (step S102). The user implements an image capturing operation at a predetermined timing by using the input nit 40 while verifying live view images. When receiving an operation signal corresponding to an image capturing operation by the user from the input unit 40, the face detection unit 10a determines that the image capturing operation has been implemented by the user (step S102: YES) and makes the image capture unit 30 capture a photographic image in response to the determination, thereby obtaining photographic image data representing the photographic image from the image capture unit 30. Since the photographic image data constitutes basically image data for storage, the image data may be made up of image data of a high resolution (the control unit 10 (the face detection part 10a) controls, for example, the image capture unit 30 so as to adjust the resolution or the like).

If the face detection part 10a determines that no image capturing operation has not been implemented by the user based on the fact that an operation signal corresponding to an image capturing operation implemented by the user has not yet been supplied (step S102: NO), returning to step S101 described above, the face detection part 10a determines whether or not the painting effect application mode has been finished. Namely, the image processor 1 waits until an image is captured by the user or the painting effect application mode is finished.

On the other hand, if the face detection part 10a determines that there has been implemented the image capturing operation (step S102: YES), the face detection part 10a determines whether or not a photographic image represented by the photographic image data includes the face of a person (step S103).

Specifically, the face detection part 10a attempts to detect an image of the face in the photographic image by an appropriate processing operation such as a template matching which uses template image data representing a predetermined face stored in advance in the storage unit 20. For example, an operation is implemented in which the image of the predetermined face (the template image) represented by the template image data is shifted pixel by pixel horizontally or vertically on the photographic image represented by the photographic image data obtained by the face detection part 10a so as to implement sequentially comparisons between the template image and an image of an area which is superposed on the template image. As this occurs, the face detection part 10a obtains sequentially similarity between the template image and the image of the area which is superposed on the template image for comparison of the similarities sequentially obtained with a preset threshold. Then, if the similarities are equal to or lager than the threshold, determining that the area which is superposed on the template image is the area of the image of the face, the face detection part 10a specifies the area as the image of the face. This specification means that the face detection part 10a has detected the face on the photographic image and determines that the face of a person is included on the photographic image. SAD (Sum of Absolute Difference), SSD (Sum of Squared Difference) or the like is used in calculation of the similarity. In addition, In the comparison of the images, the image of the predetermined face may be increased or decreased in size for comparison.

If no image of the face of a person is detected by the face detection part 10a (step S103: NO), the image turning operation implementing part 10c implements an image turning operation of turning the photographic image represented by the photographic image data into a painting-style image and displays the resulting painting-style image on the display unit 50 (step S108).

In step S108, the image turning operation implementing part 10c implements the image turning operation of turning the photographic image represented by the photographic image data into a painting-style image in accordance with the style of a painting that the user selects by using the input unit 40 when the painting effect application mode is selected. For example, when the user selects the style of a watercolor painting, the image turning operation implementing part 10c changes various parameters possessed by the photographic image data to parameters which represent the photographic image as being painted with the touch of a watercolor painting and generates painting-style image data representing the painting-style image. When referred to here, the parameters are numeric values which specify the operation intensity when implementing the image processing for turning the photographic image into the painting-style image. In addition, the parameters include parameters representing brightness, contrast, gray level, tone, sharpness and the like. Additionally, the parameters are specified by styles of paintings such as watercolor painting, color pencil sketch, pastel painting, pointillism, air brush painting, oil painting, and Gothic oil painting. As the image turning operation of turning the photographic image into the painting-style image, there is an operation using various types of filters which are used in the Photoshop (the registered trademark), for example.

The image turning operation implementing part 10c generates the painting-style image data which represent the painting-style image by implementing the above image processing operation. The image turning operation implementing part 10c stores the painting-style image data generated in a predetermined recording area (the temporary storage unit 12 shown in FIG. 2) and converts it into a display image data for supply to the display unit 50. The display unit 50 displays the painting-style image represented by the painting-style image data received on the display screen (the display panel 52 shown in FIG. 2).

If it is determined as NO in step S103, it is considered that a person (a main subject) whose image is captured positively by the user is not shown in the photographic image captured. Because of this, when the photographic image represented by the photographic image data is turned into the painting-style image, even in the event that there is a portion where the painting-style image is represented as being painted out, it is considered that that will be no problem because the image of the main subject (in particular, the face thereof) does not exist in the photographic image capture and there is caused no such situation that the image of the main subject is painted out.

In the template matching described above, the face detection part 10a may only have to use one or more template images. However, when the template images used are images which show only persons whose faces are directed to the front (persons whose line of sight is directed to the camera), persons other than a person whose face is directed to the front cannot be detected in the photographic image. For example, as is shown in FIG. 11, when a person whose face is oriented sideways is shown in the photographic image represented by the photographic image data, the face detection part 10a cannot detect the image of the face of the person. As this occurs, since it is understood from FIG. 11 that there is shown no other faces in the photographic image, the image turning operation implementing part 10c implements the image turning operation of turning the photographic image into a painting-style image.

On the other hand, if the face detection part 10a determines that the face of a person is shown in the photographic image represented by the photographic image data (step S103: YES), namely, if the image of the face is detected in the photographic image, the determination part 10b determines whether or not the image of the face of the person detected by the face detection part 10a meets a primary criterion (step S104).

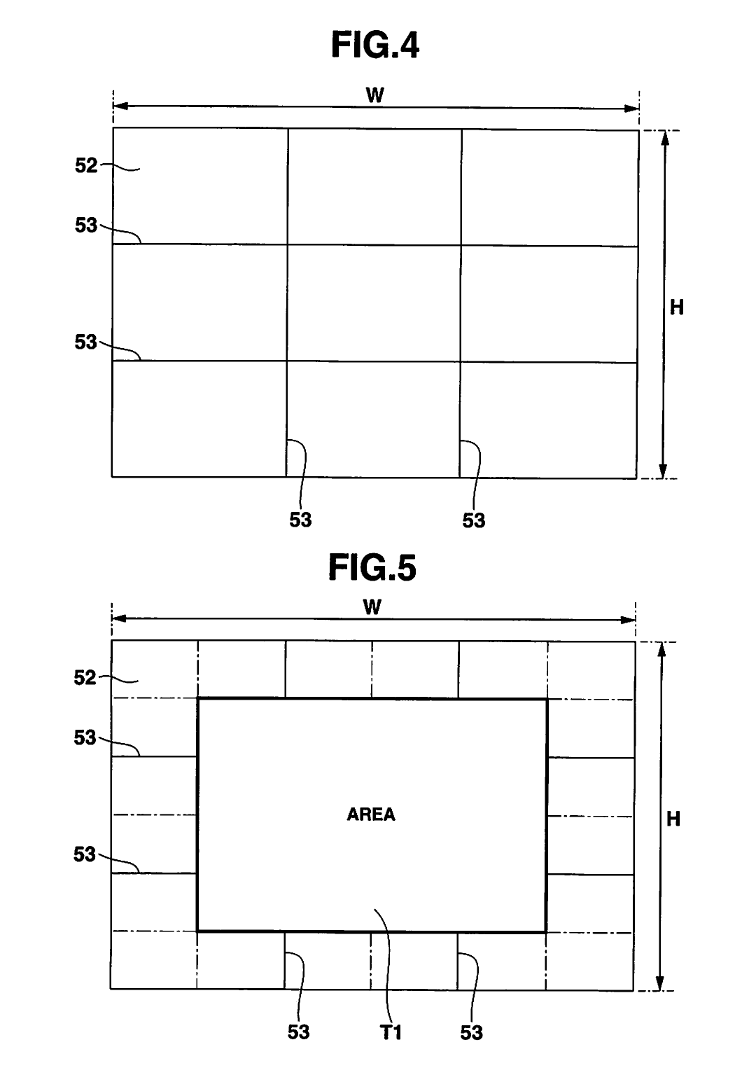

Here, the primary criterion is a criterion based on areas defined by use of the three division method. The three division method is one of rules of thumb with respect to the composition of the screen. In the three division method, as is shown in FIG. 4, two dividing lines 53 are drawn at equal intervals horizontally and vertically on an image, and the image is divided into nine portions which are equal in area in a matrix fashion. In this embodiment, for example, as is shown in FIG. 5, an area T1 is defined which is bounded by intermediate lines between the horizontal and vertical dividing lines 53 which define the nine equal portions in the three division method, which occupies about four ninth of the overall area of the photographic image in a central position thereof and which includes all intersection points of the dividing lines 53, and whether or not an image of the face of a person is included in this area T1 constitutes the first criterion.

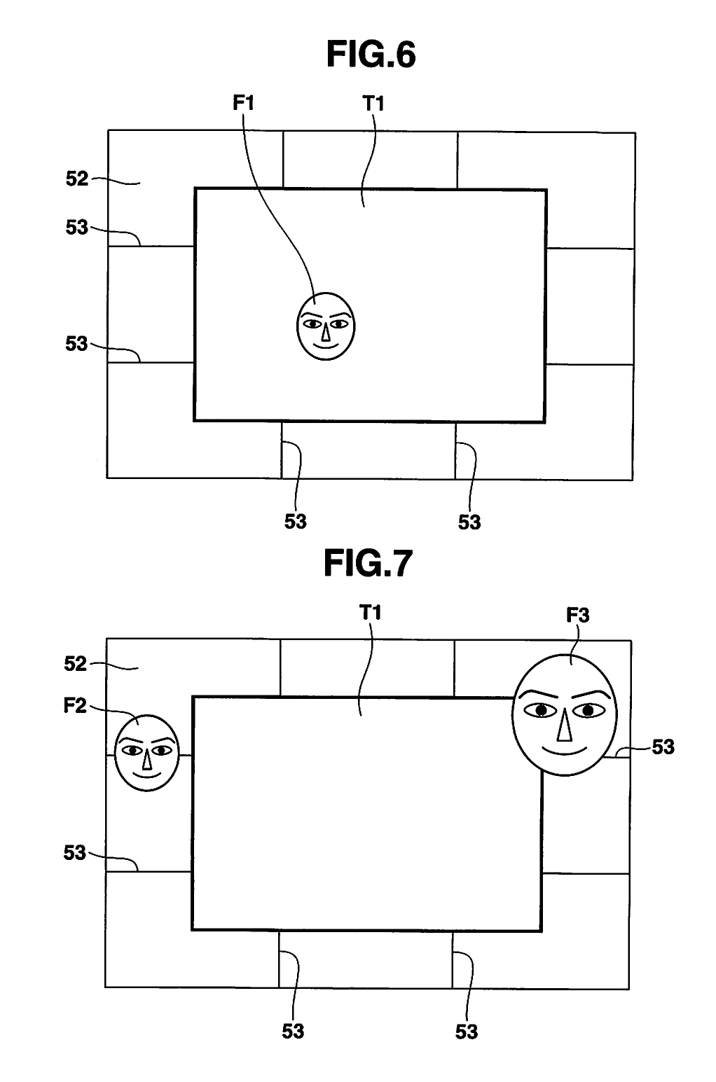

For example, as is shown in FIG. 6, when an image F1 of the face of a person (the image of the face detected above) is encompassed in the area T1, the determination part 10b determines that the image F1 of the face of the person meets the first criterion (step S104: YES). On the other hand, when an image F2 of the face of a person is not encompassed in the area T1 as is shown in FIG. 7, the determination part 10b determines that the image of the face of the person does not meet the first criterion (step S104: NO). Note that the fact that an image of the face of a person is encompassed in the area T1 means that an arbitrary point in the center of the image of the face is situated within the area T1. Consequently, for example, as is shown in FIG. 7, even when part of an image F3 of the face of a person is partially situated within the area T1, unless an arbitrary point in the center of the image F3 of the face of the person is not situated within the area T1, the determination part 10b determines that the image F3 of the face of the person does not meet the first criterion (step S104: NO). An appropriate criterion can be adopted for the criterion under which the image of the face of the person is encompassed in the area T1. For example, when the area of a portion where the image of the face of the person overlaps the area T1 is equal to or larger than a predetermined size, it may be understood that the image of the face of the person is encompassed in the area T1.

If the determination part 10c determines that the person shown in the photographic image (the image of the face detected in the photographic image, and this will be true in the following description) does not meet the first criterion (step S104: NO, refer to FIG. 7), the image turning operation implementing part 10c implements the image turning operation on the photographic image represented by the photographic image data captured by the face detection part 10a in step S102 so as to turn the photographic image into a painting-style image and displays the resulting painting-style image (step S108, refer to what has been described above for a detailed description of the operation).

In this way, when the image of the face of the person shown in the photographic image does not meet the first criterion (resides out of the area T1), the image turning operation of turning the photographic image into the painting-style image is implemented. An area residing out of the area T1 constitutes a peripheral edge portion of the photographic image and the area T1 is the area defined by the three division method. Therefore, when the image of the face of the person shown in the photographic image resides out of the area T1, it is highly possible that the image is not the image of the face of the person whose image is positively captured by the user of the camera with intension but the image of the pedestrian whose image happens to be captured by the user without any intention. Therefore, it is highly possible that the user is not interested in the person shown in the photographic image and that there will be no problem even in the event that the image turning operation is implemented on the photographic image so as to turn it into a painting-type image, resulting in the fact that the face of the person is represented as being painted out so that the user cannot recognize the face of the person in the painting-type image.

On the other hand, in step S104, if the determination part 10b determines that the image of the face of the person meets the first criterion (step S104: YES, refer to FIG. 6), on the contrary to what has been described above, it is highly possible that the image is captured by the user with intention. In this case, the determination part 10b determines whether or not the image of the face of the person detected by the face detection part 10a meets a second criterion (step S105).

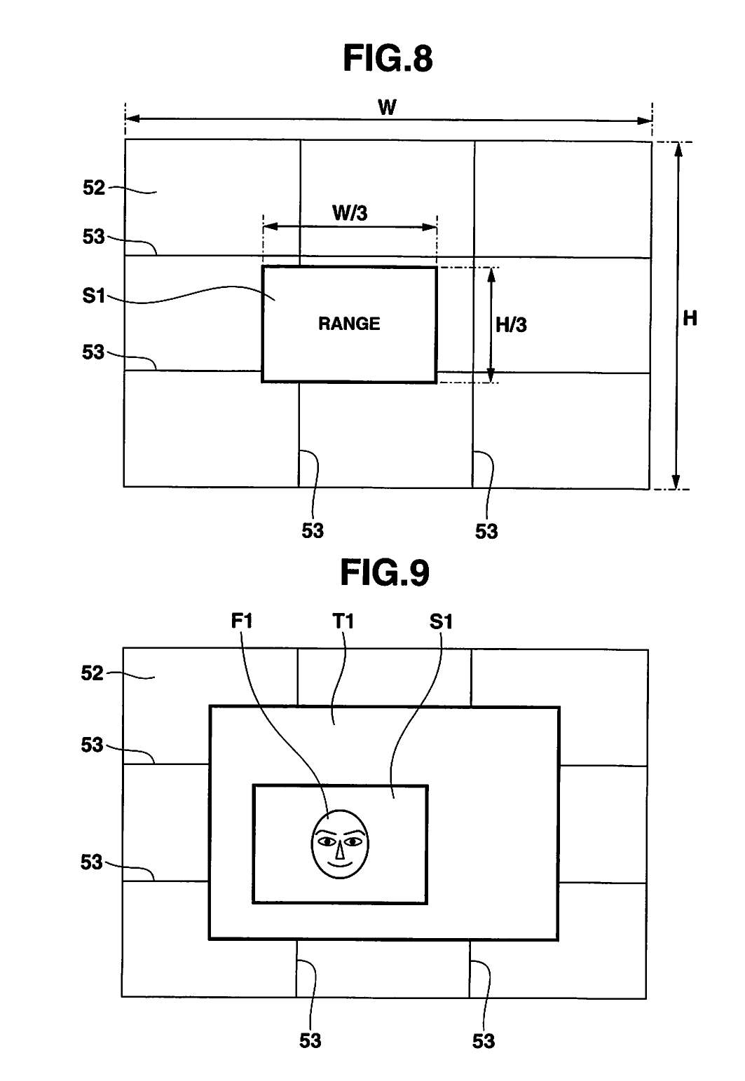

Here, the second criterion is a criterion based on whether or not the image of the face detected above is smaller in size than a preset range. For example, as is shown in FIG. 8, a rectangular range S1 which corresponds to about one ninth of the whole of the photographic image (about one fourth of the area T1) and the mage of the face are superposed one on the other with centers thereof coinciding with each other on the photographic image. Then, when the image of the face does not protrude from the range S1, it is considered that the image of the face of the person is smaller than a preset reference area and that the image of the face of the person detected by the face detection part 10a meets the second criterion (step S105: YES). On the other hand, when the image of the face protrudes from the range S1, it is considered that the image of the face of the person is larger than the preset reference area and that the image of the face of the person detected by the face detection part 10a does not meet the second criterion (step S105: NO). The determination part 10b implements the determination operation in step S105 by implementing the operations described above. Note that other methods may be adopted in determination of whether or not the image of the face of the person is smaller than the preset reference area, and hence, the determination is made based on whether or not the area exceeds a predetermined threshold.

Here, the preset reference area constitutes a criterion by which it is determined whether or not the image of the face of the person which is an object to be judged by the criterion is represented as being painted out when the photographic image is turned into a painting-type image. Namely, when the image of the face of the person shown in the photographic image is smaller than the reference area, it is highly possible that when the photographic image is turned into a painting-style image, the image of the face of the person is represented as being painted out in the resulting painting-style image. On the other hand, it is little possible that when the image of the face of the person shown in the photographic image is larger than the reference area, even in the event that the photographic image is turned into a paint-style image, the image of the face of the person is represented as being painted out in the resulting painting-style image.

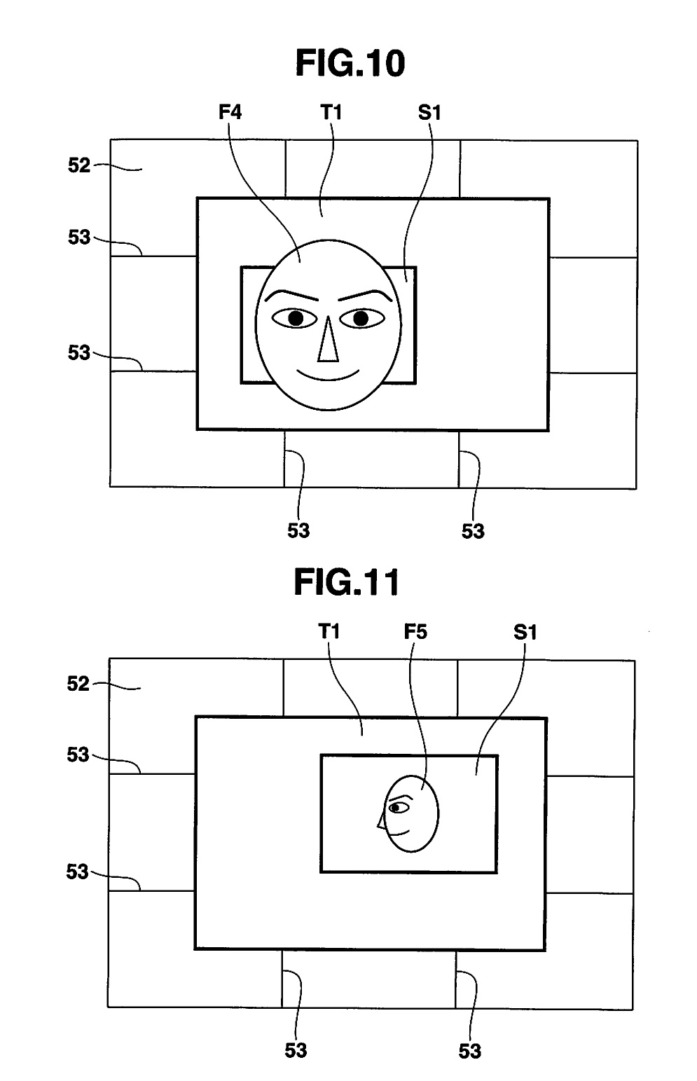

If the determination part 10b determines in step S105 that the image of the face of the person does not meet the second criterion (step S105: NO, refer to FIG. 10), the image turning operation implementing part 10c implements the operation in step S108 (refer to what has been described above for the details the operation). In this way, when the image of the face of the person shown in the photographic image does not meet the second criterion, the image turning operation of turning the photographic image into the painting-style image is implemented. Namely, in this case, even in the event that the photographic image is turned into a painting-style image, the image of the face of the person shown in the resulting painting-style image is large, and therefore, there are no fears that the image of the face of the person is represented as being painted out. Consequently, even in the event that the person shown in the photographic image is the person whose image is captured by the user of the camera with intention (even in the event that the person is the main subject), any person who looks at the painting-style image can recognize the face of the main subject shown in the painting-style image.

On the other hand, if the determination part 10b determines in step S105 that the image of the face of the person meets the second criterion (step S105: YES, refer to FIG. 9), the determination part 10b judges that since the image of the face of the person detected by the face detection part 10a is small, there are fears that the image of the face is represented as being painted out when the image turning operation is implemented. In this case, the determination part 10b determines whether or not the image of the face meets a third criterion without proceeding to step S108 (step S106).

Here, the third criterion constitutes a criterion by which whether or not the face and the line of sight of the person are directed to the front is determined. When the face and the line of sight of the person are directed to the front, it is highly possible that this person faces the camera and is looking at the camera, and it is also highly possible that the person whose image is positively captured by the user of the camera (the person constitutes a main subject). On the other hand, on any other occasions, it is highly possible that the person does not face the camera and is not looking at the camera. Therefore, it is highly possible that the person shown in the photographic image is not the person whose image is positively captured by the user of the camera (the person is a pedestrian).

The determination part 10b detects, for example, the face of the person and the direction of the line of sight from the image of the face of the person detected by the face detection part 10a. The orientation of the face of the person is detected by implementing as required an operation similar to the template matching implemented in step S102. Specifically, the determination part 10b detects, by using image data each representing eyes, nose and mouth stored in advance in the storage unit 20, the eyes, nose and mouth of the person in the image of the face of the person detected by the face detection part 10a through implementation of template matching and detects the orientation of the face based on a positional relationship between the eyes, nose and mouth which are so detected. For example, when the positions of the two eyes are aligned substantially laterally symmetrically with respect to a reference line which is a line connecting the position of the nose and the position of the mouth, the determination part 10b detects that the face of the person is oriented to the front. On the other hand, when the positions of the two eyes are aligned in a position lying close to a left-hand side with respect to the line connecting the position of the nose and the position of the mouth which is positioned centrally, the detection part 10b detects that the line of sight is directed towards the left (towards the right in an actual space).

To detect the direction of the line of sight, the positions of the pupil and the sclera are specified further from the area of the eye detected in detecting the orientation of the face of the person, whereby the direction of the line of sight is detected based on the position of the pupil within the sclera. For example, when the pupil is substantially positioned in the center of the sclera, it is detected that the line of sight is directed to the front. On the other hand, when the pupil is positioned further rightwards than the center of the sclera, the detection part 10b detects that the line of sight is directed towards the right (towards the left in the actual space).

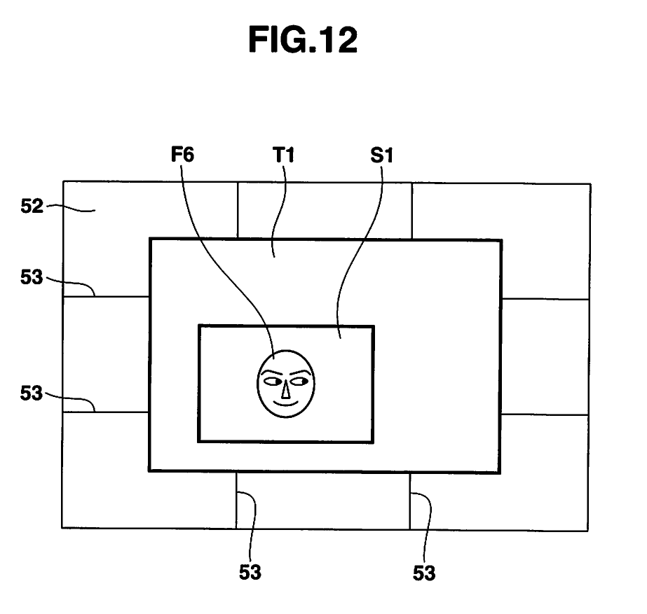

When both the face and the line of sight of the person which are specified by the image F1 of the face of the person are directed towards the front as is shown in FIG. 9, the determination part 10b determines that the image F1 of the face of the person meets the third criterion (step S106: YES). on the other hand, in case of other than what has been described above, the determination part 10b determines that the image F1 of the face of the person does not meet the third criterion (step S106: NO). For example, when the face of the person specified by an image F5 of the face of the person is not oriented towards the front as is shown in FIG. 11, the determination part 10b determines that the image F5 of the face of the person does not meet the third criterion (step S106: NO). In addition, when the line of sight of the person specified by an image F6 of the face of a person is not directed towards the front as is shown in FIG. 12, the determination part 10b determines that the image F6 of the face of the person does not meet the third criterion (step S106: NO).

When the template images represented by the template image data which are used in the template matching operation use only the images which show the persons who face the front (the persons whose lines of sight are directed to the camera), the face detection part 10a cannot detect any other persons than those who face the front in the photographic image. As this occurs, the determination part 10b does not detect the orientation of the face of the person detected (the person who faces the front) but detects the direction in which the line of sight is directed, and determines that the third criterion is met when it detects that the line of sight is directed towards the front.

In step S106, if the determination part 10b determines that the image of the face of the person does not meet the third criterion (step S106: NO, refer to FIGS. 11, 12), the image turning operation implementing part 10c implements the operation in step S108 (refer to what has been described above for the details of the operation).

When the image of the face of the person shown in the photographic image does not meet the third criterion (when at least either the face or the line of sight of the person is not oriented towards the front), the image turning operation of turning the photographic image into a painting-style image is implemented. Namely, in this case, even in the event that the photographic image is turned into the painting-style image and the image of the face of the person shown in the resulting painting-style image is represented as being painted out, it is highly possible that the person shown in the painting-style image is a pedestrian or the like in which the user of the camera is not interested, and it is highly possible that there will be no problem although the face of the person cannot be recognized.

On the other hand, in step S106, if the determination part 10b determines that the image of the face of the person meets the third criterion (step S106: YES, refer to FIG. 9), the image turning operation implementing part 10c does not implement the image turning operation of turning the photographic image represented by the photographic image data obtained by the face detection part 10a in step S102 into a painting-style image and displays the photographic image on the display screen of the display unit 50 (step S107). Namely, when the image of the face of the person meets the third criterion (both the line of sight and the face of the person are oriented towards the front), on the contrary to what has just been described above, it is highly possible that the image represents the person whose image is positively captured by the user of the camera (the image represents the main subject). In addition, in this case, when the photographic image is turned into a painting-style image, it is highly possible that the image of the face of the person shown in the resulting painting-style image is represented as being painted out and the face of the person shown in the painting-style image cannot be recognized. Then, in this case, the image turning operation implementing part 10c does not implement the image turning operation of turning the photographic image into a painting-style image and displays the photographic image represented by the photographic image data obtained by the face detection part 10a in step S102 on the display screen of the display unit 50. In addition, in this case, the image turning operation implementing part 10c displays, for example, a short sentence reading the “image turning to painting-style image is NG” on the display screen of the display unit 50, informing the user of the camera that the photographic image cannot be turned into a painting-style image.

Thus, according to the image processor 1 of the embodiment of the invention, the image of the face of the person shown in the photographic image represented by the photographic image data obtained is detected. Then, it is determined based on the fact that the image of the face of the person detected meets the first to third criteria whether or not the photographic image can be turned into a painting-style image, and the photographic image is turned into a painting-style image based on the result of the determination. In this embodiment, when the photographic image which shows the person is shown is turned into a painting-style image, whether or not the photographic image is turned into a painting-style image is determined in consideration of the position (the area T1) and the size (the range S1) where the person is shown in the photographic image or the orientation of the face and the line of sight of the person. When the image of the face of the person who is considered to constitute the main subject is small as has been described above, the image turning operation of turning the photographic image into a painting-style image is not implemented, and therefore, a drawback of the face of the person being painted out can be suppressed. In this way, in this embodiment, whether or not the image turning operation is implemented is determined in consideration of the position (the area T1) and the size (the range S1) or the orientation of the face and the line of sight of the person, that is, by making the predetermined determination on the image of the face, and therefore, a good image processing can be implemented.

In the embodiment, it is described that if the determination part 10b determines that the image of the face of the person does not meet any of the first to third criteria, the image turning operation implementing part 10c automatically implements the image turning operation of turning the photographic image into a painting-style image. However, as this occurs, the image turning operation implementing part 10c may display a short sentence reading the “image turning to painting-style image is OK” on the display screen of the display unit 50 so as to inform the user of the camera that the photographic image can be turned into a painting-style image. In this case, the user of the camera implements a selecting operation by using the input unit 40 on whether or not the photographic image be turned into a painting-style image. The image turning operation implementing part 10c may receive the operation signal corresponding to the selecting operation implemented from the input unit 40 so as to implement the image turning operation of turning the photographic image into a painting-style image in accordance with the operating signal received. In this way, the image turning operation implementing part 10c may implement the image turning operation of turning the photographic image into a painting-style image in accordance with the result of the determination made by the determination part 10b via the operation of the user of the camera.

In addition, the image turning operation implementing part 10c may implement the image turning operation of turning the photographic image into a painting-style image even when the determination part 10b determines that all of the first to third criteria are not met, that is, even in step S107. However, the intensity of the image turning operation referred to herein is made smaller than the intensity of the operation in step S108. Here, the larger the intensity of the operation, the larger the change in image before and after the image turning operation. Because of this, the change in mage before and after the image turning operation becomes small by decreasing the intensity of the image turning operation. In addition, since the intensity of the image turning operation is regulated by the parameters as has been described above, increasing or decreasing the intensity of the image turning operation is implemented by regulating the numeric values of the parameters (note that a changing method like this is performed according to a preset method). By adopting this configuration, even when the image of the face of the person who is considered to constitute the main subject in the photographic image is small, the drawback of the face of the main subject being painted out can be suppressed by implementing an image turning operation which produces a smaller change in the resulting painting-style image from the original photographic image. Moreover, since the image turning to the painting-style image can be implemented, a image can be generated which can induce the interest of the user of the camera. In addition, the image turning operation implementing part 10c may implement a (predetermined) image turning operation in step S107 which changes the image a little. By doing so, as with the case which has just been described above, the drawback of the face of the main subject being painted out can be suppressed. Moreover, since the image turning to a painting-style image can be implemented, an image is generated which induces the interest of the use of the camera.

In addition, the image turning operation implementing part 10c may implement the image turning operation by changing the intensity of the image turning operation or the styles of paintings in accordance with the results of the determinations made by the face detection part 10a or the determination part 10b in steps S103 to S106. Specifically, the image turning operation implementing part 10c changes the intensity of the image turning operation or the styles of paintings in step S108 in accordance with the negative determination NO being made in which step. For example, stored in advance in the storage unit 20 is a reference table (not shown) which records information which specifies any of the steps S103 to S106 and intensities of the operation and styles of paintings in a corresponding fashion. The image turning operation implementing part 10c specifies the step in which the negative determination NO is made (that is, the step just therebefore) and refers to the reference table to obtain an intensity of the image turning operation and a style of a painting which correspond to the information which specifies the same step as that in which the negative determination NO is made. Then, the image turning operation implementing part 10c implements the image turning operation on the photographic image based on the intensity of the image turning operation and the style of the painting obtained. Basically, the contents (existence, position and size of the image of the face of a person) of the photographic image on which the image turning operation is to be implemented in step S108 differ depending on in which of the steps S103 to S106 the negative determination NO is made. Because of this, a suitable image turning operation can be implemented on the photographic image by setting the intensity of the operation and the style of the painting in accordance with the contents which so differ.

For example, in the case described above, the intensity of the image turning operation is set so as to be decreased as the image processing proceeds from step S103 to step S106. In addition, the style of the painting is set so that the change in image before and after the image turning operation becomes small as the step in which the negative determination NO is made proceeds from step S103 to step S106. By these settings, there exists a possibility that a suitable image turning operation can be implemented on the photographic image.

Here, changing the style of the painting means that the style of the painting is changed to styles of oil painting, watercolor painting, color pencil sketch and the like, and changes in brightness and tone are also included.

In addition, changing the intensity means that even with the style of the painting remaining the same, the intensity of the image turning operation is weak when the degree at which the resulting image differs from the original image is small, whereas the intensity of the image turning operation is strong when the degree at which the resulting image differs from the original image is large.

In addition, in the embodiment, as a matter of convenience, the single person is described as being shown in the photographic image. However, the mage processor according to the invention can also be applied to a case where a plurality of persons is shown in the photographic image. In this case, for example, when the image processor 1 implements the image turning operation, in the event that there is even a single person which is determined by the determination part 10b as meeting the first to third criteria, the image turning operation implementing part 10c does not turn the photographic image into a painting-style image or implements the image turning operation by matching the intensity of the image turning operation to the person so determined.

In addition, in the embodiment, the determination part 10b determines whether or not the image of the face of the person detected by the face detection part 10a meets the criteria by using the first to third criteria. However, the user of the camera can select the first to third criteria as required for use.

Additionally, in the embodiment, the face detection part 10a is described as detecting the image of the face of the person. However, the image processor 1 of the invention can also be applied to the detection of the face of a pet such as dog, cat and the like.

Further, in the embodiment, the image processor 1 is described as turning the photographic image captured in accordance with the image capturing operation by the user of the image processor 1 into the painting-style image. However, the invention is not limited thereto, and hence, recorded images which are represented by the recorded image data recorded in the storage unit 20 and the recording medium 100 may be used to be turned into a painting-style image.

In addition, the image processor according to the invention is described as implementing the image turning operation of turning the photographic image (still image) into a painting-style image. However, the image processor 1 may implement an image turning operation of turning an image used for live view display or a dynamic or moving image (a group of images made up of a plurality of continuous still images) into a painting-style image (a group of painting-style images).

Additionally, in the embodiment, as the image processor according to the invention, the digital camera is described as the example thereof. However, the invention can also be applied to such image processors as a digital photo frame, a personal computer and the like in addition to the digital camera.

Note that the image processing program 21a of the embodiment may be recorded in a portable recording medium. This portable recording medium includes, for example, a CD-ROM (Compact Disk Read Only Memory) or a DVD-ROM (Digital Versatile Disk Read Only Memory). In addition, the image processing program 21a may be installed in the image processor 1 from the portable recording medium via a reading unit of any kind. Further, the image processing program 21a may be downloaded and installed in the image processor 1 from a network, not shown, such as the internet via a communication unit. Additionally, the image processing program 21a may be stored in a storage unit such as a server which can communicate with the image processor 1 to send a command to the CPU or the like. Further, a readable recording medium (for example, RAM, ROM (Read Only Memory), CD-R, DVD-R, hard disk, or flash memory) which records the image processing program 21a is a recording medium which records a program which can be read by a computer.

Thus, the invention is not limited to the embodiment that has been described heretofore and can be modified variously in steps of carrying it out without departing from the spirit and scope thereof. In addition, the invention may be carried out by combining as many of the functions executed in the embodiment as possible as required. The embodiment described above includes various steps and various inventions can be extracted by combining the plurality of constituent requirements disclosed as required. For example, in the event that the advantage can be obtained although some of all the constituent requirements described in the embodiment are deleted, the resulting configuration which lacks the constituent requirements so deleted can be extracted as an invention.

What is claimed is:

1. An image processor comprising:
a face detection unit for detecting an image of a face from an image;
a determination unit for determining whether or not the image of the face detected by the face detection unit meets a predetermined criterion; and
an image turning operation implementing unit for determining on an execution or non-execution of an image turning operation of turning the image into an image having a painting effect based on the result of the determination made by the determination unit.

2. The processor according to claim 1, wherein
the predetermined criterion includes a first criterion which determines whether or not the image of the face is encompassed within a predetermined area in the image, wherein
the determination unit determines that the image of the face does not meet the first criterion when the image of the face is not encompassed in the predetermined area, and wherein
the image turning operation implementing unit implements the turning operation of turning the image into an image having a painting effect when the determination unit determines that the image of the face does not meet the first criterion.

3. The image processor according to claim 1, wherein
the predetermined criterion includes a second criterion which determines whether or not the image of the face is equal to or smaller than a predetermined size, wherein
the determination unit determines that the image of the face does not meet the second criterion when the image of the face is not equal to or smaller than the predetermined size, and wherein
the image turning operation implementing unit implements the turning operation of turning the image into an image having a painting effect when the determination unit determines that the image of the face does not meet the second criterion.

4. The image processor according to claim 1, wherein
the predetermined criterion includes a third criterion which determines whether or not a direction in which the face and a line of sight are oriented is a front direction, wherein
the determination unit specifies orientations of the face and the line of sight of the person from the image of the face of the person and determines that the image of the face does not meet the third criterion when the direction in which either the face or the line of sight is oriented is not the front direction, and wherein
the image turning operation implementing unit implements the turning operation of turning the image into an image having a painting effect when the determination unit determines that the image of the face does not meet the third criterion.

5. The image processor according to claim 1, wherein
the face detection unit detects an image of the face of a person.

6. An image processor comprising:
a face detection unit for detecting an image of a face from an image;
a determination unit for determining whether or not the image of the face detected by the face detection unit meets a predetermined criterion; and
an image turning operation implementing unit for implementing an image turning operation which changes the intensity of an image turning operation of turning the image into an image having a painting effect based on the result of the determination made by the determination unit.

7. The image processor according to claim 6, wherein
the face detection unit detects an image of the face of a person.

8. An image processor comprising:
a face detection unit for detecting an image of a face from an image;
a determination unit for determining whether or not the image of the face detected by the face detection unit meets a predetermined criterion; and
an image turning operation implementing unit for implementing an image turning operation which changes the style of an image having a painting effect into which the image is turned as a result of an image turning operation based on the result of the determination made by the determination unit.

9. The image processor according to claim 8, wherein
the face detection unit detects an image of the face of a person.

10. An image processing method comprising:
a step for detecting an image of a face from an image;
a step for determining whether or not the image of the face detected meets a predetermined criterion; and
a step for determining on an execution or non-execution of an image turning operation depending on whether or not the image of the face meets the predetermined criterion and thereafter implementing the image turning operation of turning the image into an image having a painting effect when determining on execution of the image turning operation.
